(19) United States
(12) Patent Application Publication
(10) Pub. No.: US 2020/0277409 A1
(43) Pub. Date: Sep. 3, 2020

(54) SOLUBLE & FILTERABLE BIOPOLYMER SOLIDS

(71) Applicant: CARGILL, INCORPORATED, Wayzata, MN (US)

(72) Inventors: Timothy Walter ABRAHAM, Minnetonka, MN (US); Dominique LELIMOUSIN, Cretteville (FR); Jeffrey J. MALSAM, Minneapolis, MN (US); Eric Stanley SUMNER, Minneapolis, MN (US)

(73) Assignee: GARGILL, INCORPORATED, Wayzata, MN (US)

(21) Appl. No.: 16/646,871

(22) PCT Filed: Sep. 20, 2017
(86) PCT No.: PCT/US2017/052448

§ 371 Date: Mar. 12, 2020

(51) Int. Cl. C08B 37/00; C09K 8/588; C09K 8/90

(52) U.S. Cl. CPC C08B 37/0024; C09K 8/90; C09K 8/588

(57) ABSTRACT

Described herein is a beta glucan material, comprising 1,3-1,6 beta glucan, that when solubilized achieves a filterability ratio ranging from 1 to 2, preferably 1 to 1.5, and a viscosity ratio ranging from 1.5 to 4. The solubilized beta glucan materials has desired viscosity build and filterability property for EOR applications.

### TECHNICAL FIELD

The present invention relates to the preparation of a beta glucan material that when solubilized achieves desired filterability and viscosity build for enhanced oil recovery applications.

### BACKGROUND

Beta glucans are widely used as thickeners in enhanced oil recovery (EOR) applications. Particularly in off-shore applications, there is a desire to utilize such beta glucans, however given the limited amount of real estate it is desirable to receive the beta glucan in solid form, quickly solubilize or resolubilize using the water on hand and minimal equipment, wherein the solubilization/resolubilization procedure provides desirable properties, for example filterability and viscosity, necessary for enhanced oil recovery operations. The major drawback of scleroglucan polymer (a beta glucan) is its poor solubilization. Methods have been investigated and studied in this regard, however each of these methods have presented limitations.

### BRIEF SUMMARY

Described herein is a beta glucan material, comprising 1,3-1,6 beta glucan, that when solubilized achieves a filterability ratio ranging from 1 to 2, preferably 1 to 1.5, and a viscosity ratio ranging from 1.5 to 4. The solubilized beta glucan materials has desired viscosity build and filterability properties for EOR applications.

### FIGURES

FIG. 1 graphically illustrates viscosity builds of commercially available beta glucan materials and the beta glucan material described herein.

FIG. 2 graphically illustrates the filterability ratio for commercially available beta glucan materials.

### DEFINITIONS

“Average residence time” is defined as the holdup volume of the shear element divided by the average flow rate through the shear element in seconds.

“Molecular weight” is defined as the weight average molecular weight.

“Particle size distribution” is defined as the mass-median-diameter of the BG powder.

“Shear duration” is defined as average residence time (in seconds) in the shear element multiplied by the shear rate (inverse seconds).

“Solid” is defined as a solid (i.e., not a liquid or gas) at standard atmospheric conditions. For the avoidance of doubt, the term “solid” includes powders, pressed or wet cakes, and solids surrounded by an alcohol solution or hydrophobic liquid.

“Solubilized beta glucan material” is defined as the beta glucan material, in solution, obtained once the solubilized procedure is complete.

“Ultimate viscosity” is defined as the viscosity measured at a given shear rate after six passes through the specified solubilization procedure.

“Viscosity loss” is defined as the measure of viscosity after the filtration procedure compared to the viscosity before the filtration procedure.

“Viscosity ratio” is defined as the ratio of viscosity measured on a Brookfield DV2T (Spindle 21) viscometer at six revolutions per minute (rpm) compared to that measured at 60 rpm, where viscosity ratio=cP @ 6 rpm/cP @ 60 rpm (cP=centipoise).

“Viscosity build” is defined as the ratio of viscosity measured after a pass using the specified solubilization procedure divided by the ultimate viscosity, or viscosity measured after 6 passes of solubilization.

### DETAILED DESCRIPTION

Disclosed herein is a beta glucan material, comprising 1,3-1,6 beta glucan, that when solubilized, under a specified solubilization procedure, builds viscosity faster than existing commercially available beta glucan materials, provides higher filterability with minimal processing than existing commercially available beta glucan materials, and maintains viscosity throughout filterability testing.

Beta Glucan

The beta glucans (“BG”) described herein include polysaccharides classified as 1,3-1,6 beta-D-glucans and modifications thereof. According to aspects herein, the beta glucan comprises a main chain from beta-1,3-glycosidically bonded glucose units, and side groups which are formed from glucose units and are beta-1,6-glycosidically bonded thereto.

Specifically, the beta glucan described herein comprises a repeat unit defined as 3 beta-1,3-glycosidically bonded glucose units and one beta-1,6-glycosidically glucose side unit typically connected to the middle beta-1,3 glucose. The beta glucan described herein comprises at least 90% of that repeat unit in its polymeric chain.

Fungal strains which secrete such glucans are known to those skilled in the art. Examples comprise Schizophyllum commune, Sclerotium rolfsii, Sclerotium glucanicum, Monilinla fructigena, Lentinula edodes or Botrygs cinera. The fungal strains used are preferably Schizophyllum commune or Sclerotium rolfsii.

A particularly preferred beta glucan for use herein is “scleroglucan” (or, a branched beta-D-glucan with one out of three glucose molecules of the beta-(1,3)-backbone being linked to a side D-glucose unit by a (1,6)-beta bond produced from, e.g., fungi of the Sclerotium).

Another particularly preferred beta glucan for use herein is “schizophyllan” (a branched beta-D-glucan having one glucose branch for every third glucose residue in the beta-(1,3)-backbone produced from, e.g., the fungus Schizophyllan commune).

### Beta Glucan Material

The beta glucan material described herein, comprises a 1,3-1,6 beta glucan (preferred aspects of beta glucans are described above). The beta glucan material described herein comprises at least 75 wt % beta glucan. In preferred aspects, the beta glucan content (based on purification of the BG-containing broth without added material) in the beta glucan material ranges from 82 to 92 wt %. The beta glucan material is in solid form.

In certain aspects, the beta glucan material can be derived from fermentation broth or can be derived from commercially available Cargill's Actigum® CS6 or CS11 materials, however derivation of the beta glucan material is not limited to such.

The beta glucan material described herein has a molecular weight ranging from 300,000 to 8 million daltons. In preferred aspects, the molecular weight of the beta glucan material ranges from 2 to 8 million daltons, and even more preferably from 4 to 6 million daltons.

The beta glucan material described herein has a moisture content (i.e., water content) ranging from 1 to 20 wt %, and in some aspects 2 to 20 wt %. In preferred aspects, the moisture content of the beta glucan material ranges from 7-12 wt %. To achieve such moisture content it shall be understood that the beta glucan material may be thermally or mechanically dewatered. The moisture range described herein has been shown to limit stickiness of and microbial growth in the beta glucan material.

The beta glucan material described herein has a powder particle size distribution ranging from 10 to 1000 microns. In preferred aspects the particle size distribution ranges from 100 to 500 microns. Furthermore, at least 90% of the beta glucan material is retained by an 18 mesh screen and at least 90% of the beta glucan material passes through a 400 mesh screen installed on an AS 200 control sieve vibrator set at an amplitude of 180 to 190 for 3 minutes.

The beta glucan material described herein has unique properties over commercially available beta glucan materials found in the prior art because when solublized, under the solubilization procedure described below, the beta glucan material described herein achieves a filterability ratio ranging from about 1 to 2, preferably from about 1 to 1.5, and even more preferably from about 1 to 1.2. One skilled in the art will appreciate the desire in having a filterability ratio of this value as a polymer should be highly injectable to avoid plugging the rock near an injection well site. The filterability ratio is a common test to determine if a polymer has desirable high injectivity.

### Solubilization

The beta glucan material described herein has desirable properties for EOR applications such that when solubilized under a specified solubilization procedure achieves a filterabilty ratio less than about 1.5, and more preferably a filterability ratio less than about 1.2.

As to be understood, the specified solubilization procedure generally involves dispersing the beta glucan material into a solution and subjecting said solution to relatively high shear. Notably, the equipment and procedures utilized to solubilize the beta glucan material are suitable for off shore EOR applications and accommodate the limited real estate typically available in off shore EOR applications.

To begin solubilization of the beta glucan material, it is first put into solution at a concentration ranging from about 0.1 g/L to about 10 g/L. Solubilization of the beta glucan material can be carried out in either salt water or fresh water. Further, solubilization may occur in pH conditions ranging from about 6 to about 7.5 and in temperature conditions ranging from about 10° C. to 120° C., in preferred aspects from 80° C. to 120° C., and in other preferred aspects from 20° C. to about 40° C. The beta glucan material can be initially dispersed (incorporating the beta glucan material into a bulk liquid) into salt or fresh water and subjected to gentle mixing (shear rate of less than 40,000/s) for a time period of less than five minutes.

Subsequent to mixing the beta glucan material to disperse it into solution, the beta glucan material can be subjected to an in-line high shear system. In some aspects, the high shear system comprises at least one high shear element. In other aspects, the high shear system comprises at least two or at least three high shear elements. In aspects wherein there are multiple high shear elements, the shear elements are in series. The shear can be applied via many approaches known to one familiar in the art, including moving parts like a rotor-stator pair or a colloidal mixer or static devices like an orifice plate or a narrow tube with high velocity flow. The shear can also be imparted via a device that has adjustable moving parts.

The shear rate in which these shear elements operate ranges from about 40,000/s to 300,000/s, more preferably from about 100,000/s to 250,000/s, and even more preferably from about 170,000/s to 225,000/s. In aspects where there are multiple high shear elements within the in-line high shear system, the rate of the shear can be increased by at least 25% between shear elements. The average residence time in which the beta glucan material is subject to shear is less than ten seconds, in some aspects less than 5 seconds, and in other aspects less than 1 second. Further, the shear during is less than 250,000. In some aspects, the overall time from initial shear to final shear completion is less than 5 minutes and more preferably less than 1 minute. This overall time includes time spent between shear elements.

To reduce waste of the beta glucan material after passing through the high shear system one time, less than 90 wt % of the beta glucan material can be recycled back through the high shear system, and in preferred aspects, less than 10 wt % of BG material can be recycled back through the high shear system.

To ensure adequate mixing between the beta glucan material and the water source, solubilization could require between 1 and 6 passes through the shear system. Multiple passes, e.g. greater than one pass, could be required if viscosity continues to rise, with final solubilization occurring after a consistent or slightly dropping viscosity on two consecutive passes.

The beta glucan material has a purity sufficient enough that greater than 42%, and in most aspects greater than 50% of ultimate viscosity can be recovered after running the specified solubilization procedure for one pass and greater than 70% after two passes. In preferred aspects, greater than 60%, greater than 70%, and even greater than 80% of ultimate viscosity is achieved after running the specified solubilization procedure for one pass. In additional preferred aspects, greater than 80%, and even greater than 90% of ultimate viscosity is achieved after running the specified solubilization procedure for two passes. Ultimate viscosity as described herein typically ranges from about 2 cP to about 1000 cP and in preferred aspects ranges from about 50 cP to about 200 cP.

Not only does the specific solubilization procedure allow for desired viscosity build but it also provides higher filterability with minimal processing compared to existing commercially available beta glucan materials, and maintains viscosity throughout filterability testing.

Additionally, the beta glucan material described herein has a viscosity ratio ranging from 1.5 to 4. In preferred aspects the viscosity ratio ranges from 3 to 4.

Furthermore, the solubilized beta glucan material achieves less than 15% viscosity loss, in preferred aspects less than 10% viscosity loss, and in more preferred aspects less than 5% viscosity loss.

### Surfactant Systems

Surfactants have previously been used in EOR applications to enhance overall oil recovery. Accordingly, a surfactant can be added to the solubilized beta glucan material. In preferred aspects, the surfactant is an anionic surfactant. Anionic surfactants are desirable because of their strong surfactant properties, they are relatively stable, they exhibit relatively low adsorption on reservoir rock, and can be manufactured economically. Typical anionic surfactants are sulfates for low temperature EOR applications and sulfonates, and more specifically sulfonated hydrocarbons, for high temperature EOR applications. Crude oil sulfonates is a product when a crude oil is sulfonated after it's been topped, petroleum sulfonates is a product when an intermediate-molecular-weight refinery stream is sulfonated, and synthetic sulfonates is a product when a relatively purse organic compound is sulfonated. These are all examples of surfactants that may be used herein. Cationic and nonionic surfactants, while not as desirable as anionic surfactants, may also be used primarily as a cosurfactants to improve the behavior of surfactant systems. The surfactant in the solubilized beta glucan material may be generated prior to its addition to the solubilized beta glucan material or alternatively may be generated in situ. It shall also be understand that surfactant floods having a pH ranging from 9-10 are likely more compatible with the solubilized beta glucan material described herein.

### Materials & Procedures

It shall be understood that the procedures described herein should be carried out at temperatures ranging from 20-30° C. (except otherwise noted).

### Specified Solubilization Procedure

1. Prepare 30 g/l salt water solution, using deionized water and 59883 Sigma-Aldrich sea salts.
2. Use Pall stainless steel filter funnel (4280) to filter salt water through a 0.8 um EMD Millipore filter (AAWP04700) at 100-300 mL/min.
3. After filtering, check pH of salt water. Adjust to 6.3 using HCl or NaOH if outside of 6.2 to 6.4 pH range.
4. On a Fisher Scientific Isotemp mixing plate (S88857290) at 800 rpm sprinkle the beta glucan material at target concentration, specifically 1 g/L, to wall of vortex and allow it to stir for 5 minutes. (Note that if concentration at 1 g/L achieves less than 10 cP at 30 rpm and 6 passes, solubilization should be rerun such that 10-100 cP is achieved after 6 passes)
5. At 26,000 rpm, feed solution through IKA® Magic Lab® Ultra-Turrax® Inline (UTL) module equipped with the 4M generator set.
6. Measure viscosity after removing air bubbles from solution, for example by letting sample sit or accelerating the separation with a centrifuge or similar device.
7. Continue running for up to 6 passes, or until consecutive passes demonstrate a stable viscosity or a slightly decreasing viscosity.
8. The elapsed time between the beginning of Step 4 and the end of Step 7 of the specified solubilization procedure should take between 30 minutes and 2 hours.
1. Filtration Procedure (used to determine filterability ratio of solubilized beta glucan) Start with a solubilized beta glucan material made according to the specified solubilization procedure above.
2. Assemble Pall stainless steel filter housing (4280) with a 47 mm Millipore AP25 filter (AP2504700). Close exit of filter housing until ready to start flowing.
3. Pass solution through filter at 100-300 ml/min of flow
4. Assemble Pall stainless steel filter housing (4280) with a 47 mm, 1.2 μm filter, EMD Millipore cellulosic-ester filter (part # RAWP04700), with >200 mL of solution. Close exit of filter housing until ready to start flowing.
5. Place a container on a mass balance for recording mass of material passing through filter.
6. Apply pressure to the filter.
7. Open exit of filter housing and target flux of 1-3 g/s, adjusting pressure as necessary.
8. Once flow is established, maintain constant pressure during filtration testing.
9. Record time to flow 60 g, 80 g, 160 g, and 180 g of solution through the filter using the balance.
10. Calculate filterability ratio using the filterability ratio equation:

$$\frac{Time ( 180 g ) - Time ( 160 g )}{Time ( 80 g ) - Time ( 60 g )}$$

11. The elapsed time between the beginning of Step 4 of the Standard Solubilization procedure and the end of Step 9 of the Filtration Procedure should take between 30 minutes and 4 hours.

### Viscosity Measurement

Two viscometers were used on the experiment to test viscosity.
1. Viscosity measurements are carried out on degassed samples using a Brookfield DV2T (spindle 21, 6-60 rpm) viscometer, referenced as DV2T
2. Viscosity measurements are carried out on degassed samples using a Brookfield Ametek® LVT (spindle 1, 12, 30, and 60 rpm) viscometer, referenced as LVT.

### EXAMPLES

### Example 1: Viscosity Build with Commercially Available Scleroglucan

Following the specified solubilization procedure, put 2 grams per liter (g/L) Cargill Actigum® CS6, a crude powder blend of scleroglucan and sclerotium rolfsii organism powder, in solution. After mixing, add solution to IKA® Magic Lab® in UTL configuration with a 4M rotor stator pair running unit at 26,000 rpm. Set aside 50 mL of solution to measure viscosity with DV2T. With remainder of solution, pass it a second time through IKA Magic Lab using same settings and equipment. Set aside 50 mL solution to measure viscosity with DV2T. Repeat processing through Magic Lab and sampling for viscosity with DV2T a total of 6 times, or 6 passes. Table 1 provides the results of the viscosity build.

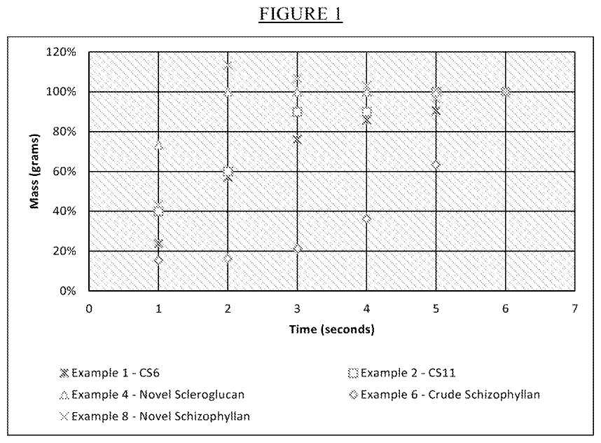

FIG. 1 illustrates the resulting viscosities from this example. As shown in FIG. 1, Actigum® CS6 does not build viscosity as quickly as the solubilized beta glucan material described herein.

TABLE 1

| | | Viscosity | Viscosity | Viscosity |
|---|---|---|---|---|
| | | Build | Build | Build |
| | | Measured | Measured | Measured |
| | Average | on | on | on |
| | Viscosity | Brookfield | Brookfield | Brookfield |
| Pass | Build | @12 rpm | @30 rpm | @60 rpm |
| 1 | 25% | 20% | 24% | 31% |
| 2 | 57% | 53% | 57% | 62% |
| 3 | 75% | 73% | 76% | 77% |
| 6 | 100% | 100% | 100% | 100% |

### Example 2: Viscosity Build with Commercially Available Scleroglucan

Following the specified solubilization procedure, put 1 g/L Cargill Actigum® CS11, a clarified scleroglucan powder, in solution. After mixing, add solution to IKA® Magic Lab® in UTL configuration with a 4M rotor stator pair running unit at 26,000 rpm. Set aside 50 mL of solution to measure viscosity with DV2T. With remainder of solution, pass it a second time through IKA Magic Lab using same settings and equipment. Set aside 50 mL of solution to measure viscosity with DV2T. Repeat processing through Magic Lab and sampling for viscosity with DV2T a total of 6 times, or 6 passes. Table 2 provides the results of the viscosity build.

TABLE 2

| | | Viscosity | Viscosity | Viscosity |
|---|---|---|---|---|
| | | Build | Build | Build |
| | | Measured | Measured | Measured |
| | Average | on | on | on |
| | Viscosity | Brookfield | Brookfield | Brookfield |
| Pass | Build | @12 rpm | @30 rpm | @60 rpm |
| 1 | 40% | 33% | 40% | 46% |
| 2 | 60% | 50% | 60% | 69% |
| 3 | 92% | 100% | 90% | 85% |
| 6 | 100% | 100% | 100% | 100% |

FIG. 1 illustrates the resulting viscosities from this example. As shown in FIG. 1, Actigum® CS11 does not build viscosity as quickly as the solubilized beta glucan described herein.

### Example 3: Production of the Beta Glucan Material (Scleroglucan) Described Herein

Using a 5000 liter jacketed vessel with moderate agitation, 7 g/L of commercial Actigum CS6 from Cargill is added to 2400 liters of 11.8° C. water and mixed for 1 hour. After an hour of mixing, the vessel is heated to 85° C. and left under agitation for 12 hours without temperature control. After 12 hours the temperature is 41.3° C. and the vessel is reheated to 80° C. and passed through a Guerin homogenizer (ALM6; Series B 8250 30 000; Year 1998) at 200 bar of pressure and 300 l/hr.

The homogenized mixture is cooled to 50° C. 4 g/L of CaCl₂*2H₂O was added. pH is reduced to 1.81 using 20% HCl. This mixture is agitated for 30 minutes to enable precipitation of oxalic acid.

After maturation, the solution is adjusted back to 5.62 pH using 10% Na₂CO₃ and heated to 85° C. and left under agitation without temperature control for 14 hours the reheated to 80° C.

After reaching 80° C. 20 g/L of Dicalite 4158 filter aid is added to the vessel and mixed for 10 minutes.

After mixing, the solution is fed to a clean Choquenet 12 m² press filter with Sefar Fyltris 25080 AM filter clothes at 1400 L/hr recycling the product back to the feed tank for 10 minutes. At the end of recycle, the flow is adjusted to 1300 L/hr and passed through the filter. Once the tank is empty an additional 50 liters of water is pushed into the filter. The fluid from this water flush and a 12 bar compression of the cake is both added to the collected permeate. The filter is cleaned after use.

The filtered permeate, water flush, and compression fluid is agitated and heated back to 80° C.

The heated mixture has 6 kg of Dicalite 4158 added and mixed for 10 minutes. At 1400 L/hr this solution is recycled through a clean Choquenet 12 m² press filter with Sefar Fyltris 25080 AM filter clothes at 1400 L/hr for 15 minutes. After the recycle, the tank is passed through the filter at 1400 L/hr.

Without cleaning the filter, 5.33 g/L of Clarcel® DICS and 6.667 g/L of Clarcel® CBL is added to the mixture and agitated for one hour while maintaining temperature at 80° C. This mixture is then recycled through the Dicalite coated Choquenet 12 m² press filter with Sefar Fyltris 25080 AM filter clothes at 1400 L/hr for 15 minutes. After the recycle, the tank is passed through the filter at 1350 L/hr. An additional 50 liters of flush water is pushed through the filter and collected as permeate as well. Compression fluid from the filter is not captured.

This twice filtered material is heated to 85° C. and left agitated without temperature control for 14 hours. At this point the material is reheated to 80° C. for a third filtration step.

The heated mixture has 6 kg of Dicalite 4158 added and mixed for 10 minutes. At 1400 L/hr this solution is recycled through a clean Choquenet 12 m² press filter with Sefar Fyltris 25080 AM filter clothes at 1400 L/hr for 15 minutes. After the recycle, the tank is passed through the filter at 1450 L/hr.

Without cleaning the filter, 5.33 g/L of Clarcel® DICS and 6.667 g/L of Clarcel® CBL is added to the mixture and agitated for one hour while maintaining temperature at 80° C. This mixture is then recycled through the Dicalite coated Choquenet 12 m² press filter with Sefar Fyltris 25080 AM filter clothes at 1600 L/hr for 15 minutes. After the recycle, the tank is passed through the filter at 1700 L/hr. An additional 50 liters of flush water is pushed through the filter and collected as permeate as well. Compression fluid from the filter is not captured.

The triple filtered permeate is cooled to 60° C. and mixed with 83% IPA at a 1:2 ratio, 2 g IPA solution for each g of scleroglucan solution. This precipitates scleroglucan fibers which can be mechanical separated from the bulk solution. In this example, a tromel separator is used to partition the precipitated fibers from the bulk liquid solution.

After recovery of the fibers they are washed with another 0.5 g 83% IPA solution for each 1 g of initial triple filtered permeate scleroglucan solution.

Wash fibers are dried in an ECI dryer (Volume 100 litres; Type 911-10; Year 1987) with 95° C. hot water for 1 hour and 13 minutes to produce a product with 89.3% dry matter. This material is ground up and sieved to provide powder smaller in size than 250 micron. This final ground scleroglucan material is the beta glucan material described herein and is used in Example 4.

### Example 4: Viscosity Build & Filterability with the Solubilized Beta Glucan Material (Scleroglucan) Described Herein

Following the specified solubilization procedure, put 1 g/L of the beta glucan material from Example 3 in solution (also known as solubilized beta glucan material). After mixing, add solution to IKA® Magic Lab® in UTL configuration with a 4M rotor stator pair running unit at 26,000 rpm. Set aside 50 mL of solution to measure viscosity with DV2T. With remainder of solution, pass it a second time through IKA Magic Lab using same settings and equipment. Set aside 50 mL of solution to measure viscosity with DV2T. Repeat processing through Magic Lab and sampling for viscosity with DV2T a total of 6 times, or 6 passes. Table 3 provides the results of the viscosity build.

TABLE 3

| | | Viscosity | Viscosity | Viscosity |
|---|---|---|---|---|
| | | Build | Build | Build |
| | | Measured | Measured | Measured |
| | Average | on | on | on |
| | Viscosity | Brookfield | Brookfield | Brookfield |
| Pass | Build | @12 rpm | @30 rpm | @60 rpm |
| 1 | 73% | 70% | 73% | 75% |
| 2 | 100% | 100% | 100% | 100% |
| 3 | 98% | 100% | 100% | 95% |
| 6 | 100% | 100% | 100% | 100% |

FIG. 1 illustrates the resulting viscosities from this example. FIG. 1 clearly shows the rapid viscosity build characteristic of the novel BG solid described herein. More specifically, FIG. 1 shows the rapid build of the novel BG solid described herein to at least 90% of ultimate viscosity in just two passes, whereas the other BG materials require more passes to reach ultimate viscosity. Further, Table 4 provides the filterability ratio of the BG solid described herein after the number of passes and as shown, the filterability ratio is always below 1.5.

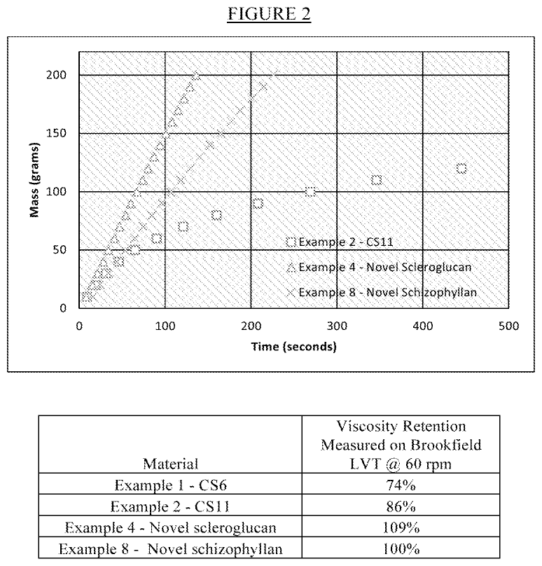

FIG. 2 shows the filterability data for the commercially available materials (in Examples 1 and 2) and the novel betaglucans. The commercially available material described in Example 1 plugged the pre-filter before passing 200 g for the filterability test. Example 2 plugged the 1.2 micron filter before passing 180 g. Because the materials in Examples 1 and 2 plugged the pre-filter and filter, the filterability ratio could not be quantified, however it shall be understood that if a filterability ratio was quantified it would exceed 1.5.

TABLE 4

| | Time (s) | | | | |
|---|---|---|---|---|---|
| Pass | 60 g | 80 g | 160 g | 180 g | FR |
| 1 | 69 | 97 | 225 | 260 | 1.25 |
| 2 | 58 | 78 | 164 | 187 | 1.15 |
| 3 | 61 | 81 | 170 | 194 | 1.2 |
| 4 | 46 | 61 | 128 | 146 | 1.2 |
| 5 | 56 | 77 | 167 | 191 | 1.14 |
| 6 | 55 | 75 | 158 | 181 | 1.15 |

### Example 5: Production of Crude Schizophyllan

Crude Schizophyllan is produced via fermentation using IAM culture collection 9006: C-180. As known to someone skilled in the art, a few grams of material is cultured in multiple steps to generate inoculum for the production fermentation run. Dosing similar nutrients and sugar as the main fermenter, each initial step is run with active oxygen transfer until roughly half the dextrose was consumed. At these small scales, fermentation is more difficult to design and run to precise specifications. Someone skilled in the art would monitor growth and contamination to generate enough material for the 10% inoculum in the production fermenter.

The production fermenter is inoculated with water, nutrients, and substrate as detailed in Table 5 below. The fermenter is a 15 liter vessel that is 462 mm tall, 202 mm in diameter, and ellipsoidal heads. To provide mixing, the vessel has an agitator with a Rushton mixing element near the bottom of 128 mm in diameter and two marine agitators higher up that all both 145 mm in diameter. Agitator starts at 200 rpm and ramps to 255 rpm over the course of fermentation shown in Table 6 below. During fermentation air is supplied at 0.8 VVM (standard volumes of air per volume of liquid per minute) and temperature is controlled to 28° C. Fermentation is stopped after 95 hours with residual dextrose between 1 to 3 g/L. Actual times and final viscosity and concentration depends on inoculum quality and specific equipment, but fermentation should end with some dextrose to avoid unwanted production of enzymes that can consume beta-glucans substrate.

TABLE 5

| Ingredient | Commercial Product Name | Mass (g) |
|---|---|---|
| Substrate (sugar) | Cargill C*Sweet D 02767 | 470 |
| KH2PO4 | KH2PO4 | 7 |
| MgSO4 | MgSO4 | 10.5 |
| Fava bean flour | CPX55 | 10 |
| Nutrient Blend | Rochette Solulys 048E | 45 |
| | (corn steep water) | |
| Oil | Sunflower Oil | 2.7 |
| AntiFoam | Breviol D102K | 4 |
| Inorganic Nitrogen | NaNO3 | 45 |
| Water | Water | 9000 |
| Innoculum | Seed train output | 1000 |

TABLE 6

| | | | Viscosity | | |
|---|---|---|---|---|---|
| | Glucose | | (cP at | BG + biomass | Agitator |
| Hours | (g/l) | pH | 7.3 s−1) | (g/L) | RPM |
| 0 | 26.3 | 4.5 | | | 200 |
| 23 | 21.4 | 4.39 | | | 215 |
| 47 | 13 | 5.33 | 350 | 4.93 | 255 |
| 55 | 11 | 5.45 | 425 | 8.77 | 255 |
| 71 | 5.5 | 5.54 | 1260 | 16.96 | 255 |
| 78.5 | 4.2 | 5.56 | 1320 | 20.16 | 255 |
| 94.5 | 1.6 | 5.66 | 1880 | 27.51 | 255 |

After fermentation is complete, the broth is heat-killed at 95° C. for 5 minutes. The solution is combined while being stirred at 1:1 with 90% IPA (isopropyl alcohol) to precipitate biomass. Using cheese cloth to retain fibers, the excess liquid is drained away from fibers. The fibers are then blended with a 90% IPA that is 50% of the initial fermentation solution volume. Using cheese cloth and 10 bar of pressure, the fibers are drained as much as possible of liquid. Afterwards they are dried in a 60° C. to 90% dry matter (10% residual water/IPA). Dried fibers were ground and classified to <500 microns to make the crude schizophyllan powder referenced in Example 6.

### Example 6: Viscosity Build with Crude Schizophyllan

Following the specified solubilization procedure, put 6 grams per liter of crude schizophyllan powder as described in Example 5 in solution. After mixing, add solution to IKA® Magic Lab® in UTL configuration with a 4M rotor stator pair running unit at 26,000 rpm. Measure viscosity using LVT viscometer. Repeat processing through Magic Lab, measuring viscosity with LVT viscometer each pass for a total of 6 passes. This material had very high levels of biomass and low viscosity, making solubilization more difficult. Cleaning of the unit was required after each pass. Stuck solids were scraped free and put back into the liquid solution before feeding the next pass through the unit. Table 7 provides the results of the viscosity build, where viscosity build is average of measured viscosity divided by the viscosity after 6 passes through the unit.

FIG. 1 illustrates the resulting viscosities from this example. As shown in FIG. 1, crude schizophyllan does not build viscosity as quickly as the solubilized beta glucan material described herein.

TABLE 7

| | | Viscosity | Viscosity | Viscosity |
|---|---|---|---|---|
| | | Build | Build | Build |
| | | Measured | Measured | Measured |
| | Average | on | on | on |
| | Viscosity | Brookfield | Brookfield | Brookfield |
| Pass | Build | @12 rpm | @30 rpm | @60 rpm |
| 1 | 17% | 11% | 15% | 24% |
| 2 | 18% | 10% | 16% | 27% |
| 3 | 25% | 19% | 21% | 34% |
| 6 | 100% | 100% | 100% | 100% |

### Example 7: Production of the Beta Glucan Material (Schizophyllan) Described Herein

Using a 15 liter jacketed fermenter, 15 g/L of crude schizophyllan from Example 5 is heated to 80° C. for one hour. After heating, the material is fed at 70° C. through a lab homogenizer (APV, Lab 2000 model) at 200-250 bar, dropping to 50° C. during processing. After homogenization, material is diluted to 8 g/L relative to the original dosing.

Next the material is passed through a coarse filtration on a Gautier filter (model ALM 2) covered with 25302 AN membranes and jacketed with 85° C. water to target an 80° C. solution temperature inside the filter. To fit the filter, 1.5 liters of diluted broth is mixed with 72 g of Dicalite 4158 filter and heated to 80° C. The mixture is put into the Gautier filter and 0.1 to 1 barg of pressure is applied, increasing over the filtration to maintain flow at 20-150 mL/min. After 20% of the original diluted broth passes, the filter is opened back open and this material is put back into the Gautier. At this point, the entire volume is passed through the filter. This filtrate carries forward to the 2^{nd} filtration step.

The second filtration step uses the same filtration equipment setup but with different filter aids. A water mixture of 0.5 liters with 10 grams of Dicalite is run through twice to apply a precoat to the filter. A dose of 5.33 g/L of Clarcel® DICS and 6.667 g/L of Clarcel® CBL is added to the coarse filtrate and agitated for one hour while maintaining temperature at 80° C. This mixture is then added to the Gautier and 20% of the volume is passed. This material is put back in the filter housing. At this point the entire volume is passed through filter and 0.1 to 1 barg of pressure is applied, increasing over the filtration to maintain flow at 20-150 mL/min. This filtrate carries forward to the 3^{rd} filtration step.

The third filtration is a duplication of the second filtration using the second filtrate instead of the coarse filtrate for feed material. The filtrate from this step carries forward to alcohol precipitation. When working with larger volumes of broth, the three filtration steps are run multiple times blending all of the third filtrate material before precipitation.

To precipitate and dry the material, the third filtrate solution is combined while being stirred at 1:1 with 90% IPA (isopropyl alcohol) to precipitate biomass. Using cheese cloth to retain fibers, the excess liquid is drained away from fibers. The fibers are then blended with a 90% IPA that is 50% of the initial fermentation solution volume. Using cheese cloth and 10 bar of pressure, the fibers are drained as much as possible of liquid. Afterwards they are dried in a 60° C. to 90% dry matter (10% residual water/IPA) in an oven (Memmert model ULM 700). Dried fibers were ground and classified to <500 microns to make the beta glucan material used in Example 8.

### Example 8: Viscosity Build with Solubilized Beta Glucan Material (Schizophyllan)) Material Described Herein

Using the specified solubilization procedure, put 1 grams per liter of beta glucan material as described in Example 7 in solution. After mixing, add solution to IKA® Magic Lab® in UTL configuration with a 4M rotor stator pair running unit at 26,000 rpm. Measure viscosity using LVT viscometer. Repeat processing through Magic Lab, measuring viscosity with LVT viscometer each pass for a total of 6 passes. Table 8 provides the results of the viscosity build, where viscosity build is average of measured viscosity divided by the viscosity after 6 passes through the unit.

FIG. 1 illustrates the resulting viscosities from this example. As shown in FIG. 1, clearly shows the rapid viscosity build characteristic of the solubilized beta glucan material (schizophyllan).

TABLE 5

| | | Viscosity | Viscosity | Viscosity |
|---|---|---|---|---|
| | | Build | Build | Build |
| | | Measured | Measured | Measured |
| | Average | on | on | on |
| | Viscosity | Brookfield | Brookfield | Brookfield |
| Pass | Build | @12 rpm | @30 rpm | @60 rpm |
| 1 | 44% | 33% | 43% | 54% |
| 2 | 122% | 142% | 113% | 110% |
| 3 | 110% | 117% | 107% | 108% |
| 6 | 100% | 100% | 100% | 100% |

The schizophyllan betaglucan material described herein demonstrated good filterability after 6 passes. The quantified filterability ratio is 1.2, based on 25 seconds to pass 160 g to 180 g and 21 seconds to pass 60 g to 80 g of material.

### Example 9: Viscosity Loss after Filterability

Table 9 provides the viscosity loss during the filtration procedure, i.e, the measure of viscosity after the filtration procedure compared to the viscosity before the filtration procedure, of various materials undergoing six passes as described in the specified solubilization procedure. As can be seen in Table 9, commercially available scleroglucan (Actigum® CS6 and CS11) and crude schizophyllan suffered more viscosity loss than the solubilized beta glucan materials (both scleroglucan and schizophyllan) described herein.

TABLE 6

| Material | Viscosity Loss |
|---|---|
| Actigum ® CS6 | 26% |
| Actigum ® CS11 | 14% |
| Scleroglucan Material | 0% |
| (as described herein) | |
| Crude Schizophyllan | Plugged AP25 |
| Schizophyllan Material | 3% |
| (as described herein) | |

### Example 10: Viscosity Build and Filterability with Dynamic Shear Equipment

Using the solubilization procedure, put 1 g/L of the BG material described herein (see Example 3 for process description) in 3 L of solution. After mixing, add solution to IKA® Magic Lab® in UTL configuration with a 4M rotor stator pair running unit at 26,000 rpm. After each pass, centrifuge solution and measure viscosity on Brookfield LVT. Set aside 220 mL for filterability testing. Repeat processing through Magic Lab and sampling for viscosity a total of 6 passes. Table 7 provides the results of the viscosity build and Table 8 shows filterability ratio for the solution.

Based on rotor geometry and 26,000 rpm the system shear is around 270,000 s⁻¹.

TABLE 7
Viscosity Build

| | | Viscosity | Viscosity | Viscosity |
|---|---|---|---|---|
| | | Build | Build | Build |
| | | Measured | Measured | Measured |
| | Average | on | on | on |
| | Viscosity | Brookfield | Brookfield | Brookfield |
| Solution | Build | @12 rpm | @30 rpm | @60 rpm |
| Feed | 9% | 3% | 9% | 14% |
| Pass 1 | 58% | 49% | 58% | 66% |
| Pass 2 | 85% | 77% | 87% | 92% |
| Pass 3 | 98% | 93% | 98% | 102% |
| Pass 4 | 94% | 87% | 95% | 100% |
| Pass 5 | 91% | 84% | 93% | 98% |
| Pass 6 | 88% | 77% | 89% | 97% |

TABLE 8
Filterability Ratio

| | Filterability |
|---|---|
| Pass Outlet | Ratio |
| Pass 1 | 2.52 |
| Pass 2 | 1.91 |
| Pass 3 | 1.23 |
| Pass 4 | 1.19 |
| Pass 5 | 1.15 |
| Pass 6 | 1.31 |

### Example 11: Viscosity and Filterability Using Low Shear Rate

Prepare synthetic sea water solution using deionized water and Sigma Aldrich Sea salts (S9883) at 30 g/l salt. Agitate water on a stir plate, add sea salts, allow to agitate until no solids are visible. Filter salt water through a 0.8 um EMD Millipore Mixed Cellulose Ester filter.

Assemble apparatus according to American Petroleum Institute (API) Recommended Practice (RP) 63, 6.6.2 Capillary Shear Test. Use 0.05″ diameter, 20 cm long capillary tube.

Prepare 3.5 kg of solution. Weigh appropriate synthetic sea water and polymer to produce a final beta glucan material concentration of 1 g/l (using beta glucan material from Example 3). Agitate synthetic sea water on a stir plate to form a vortex. Slowly sprinkle the beta glucan material into the shoulder of the vortex, over 2 to 3 minutes, taking care to avoid creating any clumps. Allow to agitate on stir plate for 5 minutes.

Add beta glucan material, in solution, to the McMaster-Carr 41705K39 tank. Seal tank and pressurize to desired pressure (according to Table 8). Open valve on discharge of tank, and measure the flow rate of beta glucan solution as it flows out of the tank. Use equation from API RP 63, 6.6.2.3 to calculate the shear rate as the solution passes through the capillary. ‘Pass’ listed in Table 9 refers to the number of times this process is repeated at the given pressure. For example, the 10 psi/30,000 s-1 sample was added to the tank, pressurized, and passed through the capillary 6 times. ‘Sample’ listed in Table 8 outlines the process order. That is, the sample was processed for 6 passes at 30,000 s-1 shear, viscosity and filterability were measured. Then it was processed for 2 passes at 65,000 s-1 shear, viscosity and filterability measured again, and so on. Viscosity and filterability are also given in Table 9. Viscosity was measured using a Brookfield LVT viscometer at 30 rpm and 21-23° C.

The filterability ratio at different shear rates confirms the need for >40,000 s-1 to achieve a desirable injectable solubilized beta glucan. In particular, at the lower shear rate of 30,000 s-1 the solution was run through the equipment 6 times and still had a poor filterability ratio and lower viscosity than with higher shear rates.

TABLE 9

| | Pressure | Shear | | Viscosity | Filterability |
|---|---|---|---|---|---|
| Sample # | (psi) | (s−1) | Pass | (cP) | Ratio |
| 1 | 10 | 30,000 | 6 | 28 | 2.74 |
| 2 | 30 | 65,000 | 2 | 36 | 1.56 |
| 3 | 50 | 90,000 | 2 | 34 | 1.48 |
| 4 | 80 | 114,000 | 2 | 34 | 1.27 |
| 5 | 120 | 140,000 | 2 | 32 | 1.32 |
| 6 | 180 | 168,000 | 2 | 30 | 1.29 |

1. A beta glucan material, comprising solid 1,3-1,6 beta glucan, that when solubilized achieves a filterability ratio ranging from 1 to 2 and a viscosity ratio ranging from 1.5 to 4.

2. The beta glucan material of claim 1 that when solubilized achieves at least 90% ultimate viscosity.

3. The beta glucan material of claim 1 that achieves greater than 42% of ultimate viscosity after one pass after running solubilization procedure and greater than 70% of ultimate viscosity after two passes.

4. The beta glucan material of claim 3, wherein greater than 60% of ultimate viscosity is achieved after running solubilization procedure for one pass.

5. The beta glucan material of claim 3, wherein greater than 70% of ultimate viscosity is achieved after running solubilization procedure for one pass.

6. The beta glucan material of claim 3, wherein greater than 80% of ultimate viscosity is achieved after running solubilization procedure for one pass.

7. The beta glucan material of claim 3, wherein greater than 80% of ultimate viscosity is achieved after running solubilization procedure for two passes.

8. The beta glucan material of claim 3, wherein greater than 90% of ultimate viscosity is achieved after running solubilization procedure for two passes.

9. The beta glucan material of claim 1, wherein the filterability ratio ranges from 1 to 1.5.

10. The beta glucan material of claim 1, wherein the filterability ratio ranges from 1 to 1.2.

11. The beta glucan material of claim 1 that when solubilized achieves less than 13% viscosity loss.

12. The beta glucan material of claim 1 that when solubilized achieves less than 10% viscosity loss.

13. The beta glucan material of claim 1 that when solubilized achieves less than 5% viscosity loss.

14. The beta glucan material of claim 1 that when solubilized achieves a viscosity ranging from 2 cP to about 1000 cP.

15. The beta glucan material of claim 1 that when solubilized achieves a viscosity ranging from 50 cP to about 200 cP.

16. The beta glucan material of claim 1 wherein the beta glucan is scleroglucan.

17. The beta glucan material of claim 1 wherein the beta glucan is schizophyllan.

18. The beta glucan material of claim 1 wherein the material comprises at least 75 wt % beta glucan.

19. The beta glucan material of claim 1 wherein the material has a molecular weight ranging from 300,000 to 8 million daltons.
